(19) United States
(12) Patent Application Publication
(10) Pub. No.: US 2012/0068983 A1
(43) Pub. Date: Mar. 22, 2012

(54) SWITCHABLE ORGANIC ELECTRO- LUMINESCENCE DISPLAY PANEL AND SWITCHABLE ORGANIC ELECTRO-LUMINESCENCE DISPLAY CIRCUIT

(75) Inventors: Tsung-Ting Tsai, Tainan City (TW); Yuan-Chun Wu, Taoyuan County (TW)

(73) Assignee: AU OPTRONICS CORPORATION, Hsinchu (TW)

(21) Appl. No.: 12/960,552

(22) Filed: Dec. 6, 2010

(30) Foreign Application Priority Data
Sep. 21, 2010 (TW) 99132038

(51) Int. Cl. G09G 3/30; G06F 3/038

(52) U.S. Cl. 345/211; 345/76

(57) ABSTRACT

A switchable organic electro-luminescence display circuit includes a plurality of scan lines, a plurality of data lines, a plurality of first organic electro-luminescence devices, a plurality of second organic electro-luminescence devices, a display mode switching line, and at least one display mode switching transistor. Each of the first organic electro-luminescence devices is electrically connected to a scan line and a data line correspondingly, and coupled between a first voltage source and a second voltage source. Each of the second organic electro-luminescence devices is electrically connected to a scan line and a data line correspondingly, and coupled to the first voltage source. A gate electrode of the display mode switching transistor is electrically connected to the display mode switching line. A source electrode and a drain electrode of the display mode switching transistor are electrically connected to the second voltage source and the second organic electro-luminescence devices respectively.

### CROSS-REFERENCE TO RELATED APPLICATION

This application claims the priority benefit of Taiwan application serial no. 99132038, filed on Sep. 21, 2010. The entirety of the above-mentioned patent application is hereby incorporated by reference herein and made a part of this specification.

### BACKGROUND OF THE INVENTION

1. Field of the Invention

The invention relates to a display panel and a display circuit. More particularly, the invention relates to a switchable organic electro-luminescence display panel and a switchable organic electro-luminescence display circuit.

2. Description of Related Art

An organic electro-luminescence device is characterized by self-luminance, high brightness, high contrast, wide view angle, fast response speed, and so on. Therefore, among various displays, an organic electro-luminescence display panel continuously draws attention. Generally, the organic electro-luminescence device can be categorized into a top-emission organic electro-luminescence device, a bottom-emission organic electro-luminescence device, and a dual-emission organic electro-luminescence device. In the same pixel, only one display device is configured in most cases. Hence, the display mode (e.g., single-sided display or double-sided display) and display directions (e.g., front display or back display) of the display panel are often fixed. That is to say, the display effect achieved by the conventional display panel remains unchanged.

### SUMMARY OF THE INVENTION

The invention is directed to a switchable organic electro-luminescence display panel and a switchable organic electro-luminescence display circuit that are capable of switching the display panel to have different display effects.

The invention provides a switchable organic electro-luminescence display panel that includes a substrate, a plurality of scan lines, a plurality of data lines, a plurality of organic electro-luminescence display pixels, and a first display mode switching circuit. The substrate has a display region and a peripheral region. The scan lines are configured on the substrate. The data lines are configured on the substrate and intersected with the scan lines. The organic electro-luminescence display pixels are configured in the display region. Each of the organic electro-luminescence display pixels is electrically connected to one of the scan lines and one of the data lines correspondingly. Besides, each of the organic electro-luminescence display pixels includes a first organic electro-luminescence device and a second organic electro-luminescence device. The first organic electro-luminescence device is coupled between a first voltage source and a second voltage source. The first organic electro-luminescence device and the second organic electro-luminescence device are electrically connected to the same scan line and emit light in different mode. The second organic electro-luminescence device is coupled between the first voltage source and the second voltage source. The first display mode switching circuit is configured in the peripheral region. Besides, the first display mode switching circuit includes a first display mode switching line and at least one display mode switching transistor. The first display mode switching transistor includes a first display switching gate electrode, a first display switching source/drain electrode, and a second display switching source/drain electrode. The first display switching gate electrode is electrically connected to the first display mode switching line. The first display switching source/drain electrode is electrically connected to the first voltage source. The second display switching source/drain electrode is electrically connected to all of the second organic electro-luminescence devices.

According to an embodiment of the invention, the first organic electro-luminescence device is a bottom-emission organic electro-luminescence device, a top-emission organic electro-luminescence device, or a dual-emission organic electro-luminescence device, and the second organic electro-luminescence device is a bottom-emission organic electro-luminescence device, a top-emission organic electro-luminescence device, or a dual-emission organic electro-luminescence device.

According to an embodiment of the invention, the first organic electro-luminescence device and the second organic electro-luminescence device in each of the organic electro-luminescence display pixels are electrically connected to the same data line.

According to an embodiment of the invention, the switchable organic electro-luminescence display panel further includes a second display mode switching circuit. Each of the first organic electro-luminescence devices is electrically connected to the first voltage source through the second display mode switching circuit.

According to an embodiment of the invention, the first organic electro-luminescence device in each of the organic electro-luminescence display pixels includes a first organic electro-luminescence diode, a switching transistor, a first drive transistor, and a capacitor. The first organic electro-luminescence diode has a first end and a second end, and the second end is electrically connected to the second voltage source. The switching transistor has a first gate electrode, a first source electrode, and a first drain electrode. The first gate electrode is electrically connected to one of the scan lines, and the first source electrode is electrically connected to one of the data lines correspondingly. The first drive transistor has a second gate electrode, a second source electrode, and a second drain electrode. The second gate electrode is electrically connected to the first drain electrode, the second source electrode is electrically connected to the first voltage source, and the second drain electrode is electrically connected to the first end. The capacitor is coupled between the first drain electrode and the second source electrode.

According to an embodiment of the invention, the second organic electro-luminescence device in each of the organic electro-luminescence display pixels includes a second organic electro-luminescence diode and a second drive transistor. The second organic electro-luminescence diode has a third end and a fourth end, and the fourth end is electrically connected to the second voltage source. The second drive transistor has a third gate electrode, a third source electrode, and a third drain electrode. The third gate electrode is electrically connected to the first drain electrode, the third source electrode is electrically connected to the first voltage source through the first display mode switching circuit, and the third drain electrode is electrically connected to the third end.

According to an embodiment of the invention, the first organic electro-luminescence device in each of the organic electro-luminescence display pixels includes a first organic electro-luminescence diode, a switching transistor, a first drive transistor, and a capacitor. The first organic electro-luminescence diode has a first end and a second end, and the first end is electrically connected to the first voltage source. The switching transistor has a first gate electrode, a first source electrode, and a first drain electrode. The first gate electrode is electrically connected to one of the scan lines, and the first source electrode is electrically connected to one of the data lines correspondingly. The first drive transistor has a second gate electrode, a second source electrode, and a second drain electrode. The second gate electrode is electrically connected to the first drain electrode, the second source electrode is electrically connected to the second end, and the second drain electrode is electrically connected to the second voltage source. The capacitor is coupled between the first drain electrode and the second source electrode or between the first drain electrode and the first voltage source.

According to an embodiment of the invention, the second organic electro-luminescence device in each of the organic electro-luminescence display pixels includes a second organic electro-luminescence diode and a second drive transistor. The second organic electro-luminescence diode has a third end and a fourth end, and the third end is electrically connected to the first voltage source through the first display mode switching circuit. The second drive transistor has a third gate electrode, a third source electrode, and a third drain electrode. The third gate electrode is electrically connected to the first drain electrode, the third source electrode is electrically connected to the fourth end, and the third drain electrode is electrically connected to the second voltage source.

According to an embodiment of the invention, the second organic electro-luminescence device in each of the organic electro-luminescence display pixels includes a second organic electro-luminescence diode and a second drive transistor. The second organic electro-luminescence diode has a third end and a fourth end, and the third end is electrically connected to the first voltage source. The second drive transistor has a third gate electrode, a third source electrode, and a third drain electrode. The third gate electrode is electrically connected to the first drain electrode, the third source electrode is electrically connected to the fourth end, and the third drain electrode is electrically connected to the second voltage source through the first display mode switching circuit.

According to an embodiment of the invention, the first organic electro-luminescence device and the second organic electro-luminescence device in each of the organic electro-luminescence display pixels are electrically connected to different data lines.

According to an embodiment of the invention, the first organic electro-luminescence device in each of the organic electro-luminescence display pixels includes a first organic electro-luminescence diode, a first switching transistor, a first drive transistor, and a first capacitor. The first organic electro-luminescence diode has a first end and a second end, and the second end is electrically connected to the second voltage source. The first switching transistor has a first gate electrode, a first source electrode, and a first drain electrode. The first gate electrode is electrically connected to one of the scan lines, and the first source electrode is electrically connected to one of the data lines correspondingly. The first drive transistor has a second gate electrode, a second source electrode, and a second drain electrode. The second gate electrode is electrically connected to the first drain electrode, the second source electrode is electrically connected to the first voltage source, and the second drain electrode is electrically connected to the first end. The first capacitor is coupled between the first drain electrode and the second source electrode.

According to an embodiment of the invention, the second organic electro-luminescence device in each of the organic electro-luminescence display pixels includes a second organic electro-luminescence diode, a second switching transistor, a second drive transistor, and a second capacitor. The second organic electro-luminescence diode has a third end and a fourth end, and the third end is electrically connected to the second voltage source. The second switching transistor has a third gate electrode, a third source electrode, and a third drain electrode. The third gate electrode is electrically connected to one of the scan lines, and the third source electrode is electrically connected to one of the data lines correspondingly. The second drive transistor has a fourth gate electrode, a fourth source electrode, and a fourth drain electrode. The fourth gate electrode is electrically connected to the third drain electrode, the fourth source electrode is electrically connected to the first voltage source, and the fourth drain electrode is electrically connected to the third end. The second capacitor is coupled between the third drain electrode and the fourth source electrode.

The invention also provides a switchable organic electro-luminescence display panel that includes a substrate, a plurality of scan lines, a plurality of data lines, a plurality of organic electro-luminescence display pixels, and a first display mode switching circuit. The substrate has a display region and a peripheral region. The scan lines are configured on the substrate. The data lines are configured on the substrate and intersected with the scan lines. The organic electro-luminescence display pixels are configured in the display region. Each of the organic electro-luminescence display pixels is electrically connected to one of the scan lines and one of the data lines correspondingly. Besides, each of the organic electro-luminescence display pixels includes a first organic electro-luminescence device and a second organic electro-luminescence device. The first organic electro-luminescence device and the second organic electro-luminescence device are electrically connected to the same scan line and emit light in different mode. The first display mode switching circuit is configured in the peripheral region. Each of the first organic electro-luminescence devices is forward-coupled between a first voltage source and a second voltage source, and each of the second organic electro-luminescence devices is electrically connected to the first voltage source or the second voltage source through the first display mode switching circuit.

The invention further provides a switchable organic electro-luminescence display circuit that includes a plurality of scan lines, a plurality of data lines, a plurality of organic electro-luminescence display pixels, a first display mode switching line, and at least one first display mode switching transistor. The data lines are intersected with the scan lines. Each of the first organic electro-luminescence devices is electrically connected to one of the scan lines and one of the data lines correspondingly and coupled between a first voltage source and a second voltage source. Each of the second organic electro-luminescence devices is electrically connected to one of the scan lines and one of the data lines correspondingly and coupled to the first voltage source. The first display mode switching transistor includes a first display switching gate electrode, a first display switching source/drain electrode, and a second display switching source/drain electrode. The first display switching gate electrode is electrically connected to the first display mode switching line. The first display switching source/drain electrode is electrically connected to the second voltage source. The second display switching source/drain electrode is electrically connected to one of the second organic electro-luminescence devices.

Based on the above, in the switchable organic electro-luminescence display panel and the switchable organic electro-luminescence display circuit of the invention, each of the organic electro-luminescence display pixels has the first and second organic electro-luminescence devices. The second organic electro-luminescence device is controlled by the first display mode switching circuit. Moreover, the first organic electro-luminescence device can further be controlled by the second display mode switching circuit. The first organic electro-luminescence device and the second organic electro-luminescence device emit light in different mode. Thereby, the organic electro-luminescence display panel can be switched to have different display effects.

In order to make the aforementioned and other features and advantages of the invention comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a system block view illustrating an organic electro-luminescence display panel according to an embodiment of the invention.

FIG. 2 is a schematic circuit diagram illustrating a portion of the first display mode switching circuit 114 and the organic electro-luminescence display pixel 112 according to a first embodiment of the invention.

FIG. 3 is a schematic circuit diagram illustrating a portion of the first display mode switching circuit 114 and the organic electro-luminescence display pixel 112 according to a second embodiment of the invention.

FIG. 4 is a schematic circuit diagram illustrating a portion of the first display mode switching circuit 114 and the organic electro-luminescence display pixel 112 according to a third embodiment of the invention.

FIG. 5 is a schematic circuit diagram illustrating a portion of the first display mode switching circuit 114, the organic electro-luminescence display pixel 112, and a portion of the second display mode switching circuit 530 according to a fourth embodiment of the invention.

FIG. 6 is a schematic circuit diagram illustrating a portion of the first display mode switching circuit 114, the organic electro-luminescence display pixel 112, and a portion of the second display mode switching circuit 630 according to a fifth embodiment of the invention.

FIG. 7 is a top view illustrating the organic electro-luminescence display pixel 112 according to an embodiment of the invention.

FIG. 8 is a cross-sectional view illustrating a portion of the organic electro-luminescence display pixel 112 according to an embodiment of the invention.

### DETAILED DESCRIPTION OF EMBODIMENTS

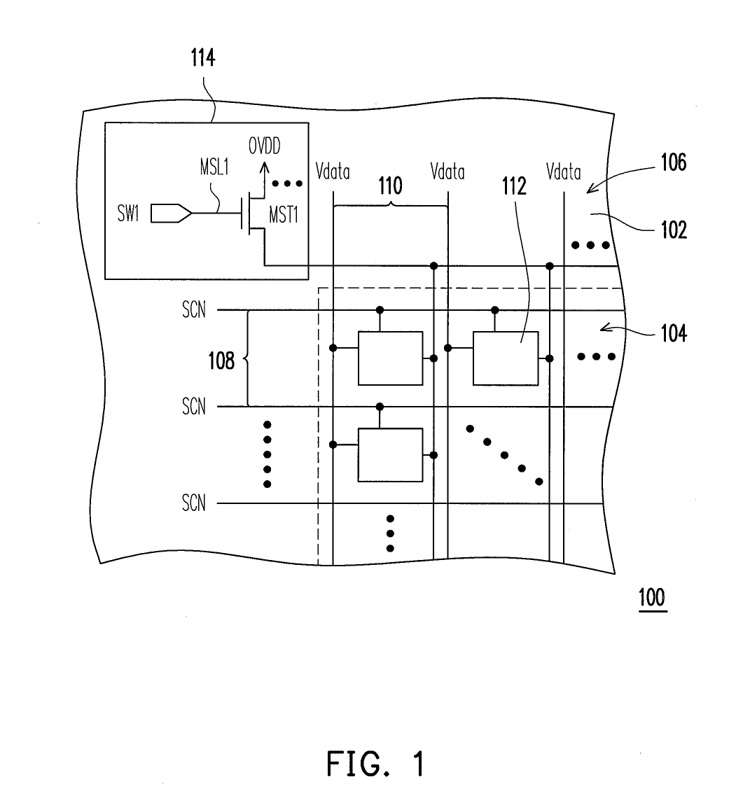

FIG. 1 is a system block view illustrating an organic electro-luminescence display panel according to an embodiment of the invention. As shown in FIG. 1, the organic electro-luminescence display panel 100 of this embodiment includes a substrate 102, a plurality of scan lines 108, a plurality of data lines 110, a plurality of organic electro-luminescence display pixels 112, and a first display mode switching circuit 114. The scan lines 108 and the data lines 110 are configured on the substrate 102, and the scan lines 108 are intersected with the data lines 110. Here, the scan lines 108 transmit scan signals SCN, and the data lines 110 transmit data signals Vdata. The substrate 102 has a display region 104 and a peripheral region 106. The organic electro-luminescence display pixels 112 are configured in the display region 104, and each of the organic electro-luminescence display pixels 112 is electrically connected to one of the scan lines 108 and one of the data lines 110 correspondingly. The first display mode switching circuit 114 is configured in the peripheral region 106 and electrically connected to each of the organic electro-luminescence display pixels 112.

The first display mode switching circuit 114, as shown in FIG. 1, includes at least one first display mode switching transistor MST1 and a first display mode switching line MSL1. When the at least one first display mode switching transistor MST1 refers to a plurality of first display mode switching transistors MST1 that are serially connected, the number of the first display mode switching transistors MST1 corresponds to the column number of the organic electro-luminescence display pixels 112. Here, the first display mode switching transistor MST1 is the n-type metal oxide semiconductor (NMOS) transistor, for instance. The gate electrode of the first display mode switching transistor MST1 is electrically connected to the first display mode switching line MSL1 to receive a mode switching signal SW1. The source electrode of the first display mode switching transistor MST1 is electrically connected to a first voltage source OVDD. The drain electrode of the first display mode switching transistor MST1 is electrically connected to all corresponding organic electro-luminescence display pixels 112. When the at least one first display mode switching transistor MST1 refers to a plurality of first display mode switching transistors MST1, the first display mode switching line MSL1 is serially connected to the gate electrodes of the first display mode switching transistors MST1, the source electrodes of the first display mode switching transistors MST1 are electrically connected to the first voltage source OVDD, and the drain electrode of each of the first display mode switching transistors MST1 is electrically connected to the organic electro-luminescence display pixels 112 arranged in the corresponding column. In other embodiments of the invention, the first display mode switching transistor MSTI can also be a p-type metal oxide semiconductor (PMOS) transistor.

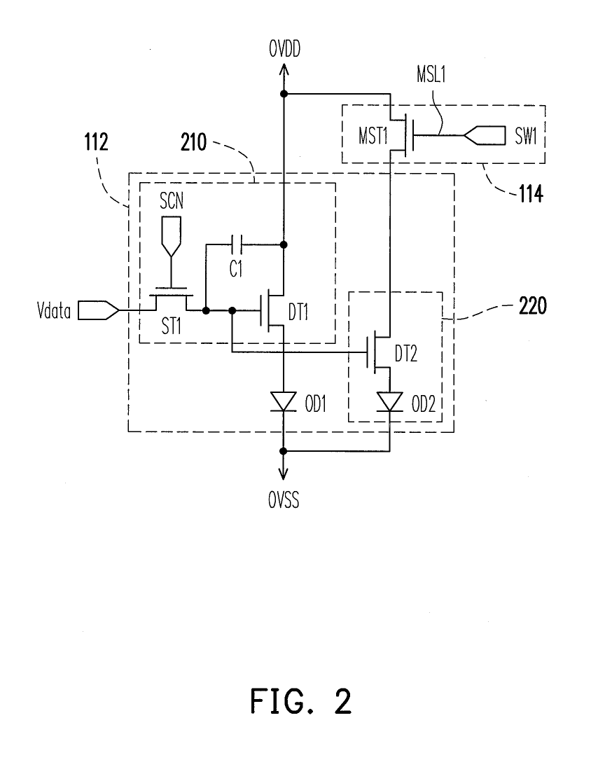

FIG. 2 is a schematic circuit diagram illustrating a portion of the first display mode switching circuit 114 and the organic electro-luminescence display pixel 112 according to a first embodiment of the invention. As shown in FIG. 2, the first display mode switching circuit 114 merely has one first display mode switching transistor MST1 and one first display mode switching line MSL1 for the descriptive purpose according to this embodiment, which should not be construed as a limitation to the first display mode switching circuit 114 of the invention. Each of the organic electro-luminescence display pixels 112 includes a first organic electro-luminescence device 210 and a second organic electro-luminescence device 220. Here, the first organic electro-luminescence device 210 and the second organic electro-luminescence device 220 can be bottom-emission organic electro-luminescence devices, top-emission organic electro-luminescence devices, or dual-emission organic electro-luminescence devices, and the first organic electro-luminescence device 210 and the second organic electro-luminescence device 220 emit light in different mode.

The first organic electro-luminescence device 210 is forward-coupled between the first voltage source OVDD and a second voltage source OVSS. The second organic electro-luminescence device 220 is electrically connected to the second voltage source OVSS. Besides, the second organic electro-luminescence device 220 is electrically connected to the drain electrode of the first display mode switching transistor MSTI, so as to electrically connect the first voltage source OVDD through the first display mode switching circuit 114.

As shown in FIG. 1 and FIG. 2, the first organic electro-luminescence device 210 includes a first organic electro-luminescence diode OD1, a first switching transistor ST1, a first drive transistor DT1, and a first capacitor C1. The first switching transistor ST1 and the first drive transistor DT1 of this embodiment are NMOS transistors, for instance. The cathode (i.e., the second end) of the first organic electro-luminescence diode OD1 is electrically connected to the second voltage source OVSS. The gate electrode (i.e., the first gate electrode) of the first switching transistor ST1 is electrically connected to the corresponding scan line 108 to receive the corresponding scan signal SCN. The source electrode (i.e., the first source electrode) of the first switching transistor ST1 is electrically connected to the corresponding data line 110 to receive the corresponding data signal Vdata.

The gate electrode (i.e., the second gate electrode) of the first drive transistor DT1 is electrically connected to the drain electrode (i.e., the first drain electrode) of the first switching transistor ST1. The source electrode (i.e., the second source electrode) of the first drive transistor DT1 is electrically connected to the first voltage source OVDD. The drain electrode (i.e., the second drain electrode) of the first drive transistor DT1 is electrically connected to the anode (i.e., the first end) of the first organic electro-luminescence diode OD1. The first capacitor C1 is coupled between the drain electrode of the first switching transistor ST1 and the source electrode of the first drive transistor DT1.

When the first organic electro-luminescence device 210 is the bottom-emission organic electro-luminescence device, the first organic electro-luminescence diode OD1 is correspondingly a bottom-emissive organic electro-luminescence diode. When the first organic electro-luminescence device 210 is the top-emission organic electro-luminescence device, the first organic electro-luminescence diode OD1 is correspondingly a top-emissive organic electro-luminescence diode. When the first organic electro-luminescence device 210 is the dual-emission organic electro-luminescence device, the first organic electro-luminescence diode OD1 is correspondingly a dual-emissive organic electro-luminescence diode.

The second organic electro-luminescence device 220 includes a second organic electro-luminescence diode OD2 and a second drive transistor DT2. In this embodiment, the second drive transistor DT2 is an NMOS transistor, for instance. The cathode (i.e., the fourth end) of the second organic electro-luminescence diode OD2 is electrically connected to the second voltage source OVSS. The gate electrode (i.e., the third gate electrode) of the second drive transistor DT2 is electrically connected to the drain electrode of the first switching transistor ST1. The source electrode (i.e., the third source electrode) of the second drive transistor DT2 is electrically connected to the drain electrode of the first display mode switching transistor MST1, so as to electrically connect the first voltage source OVDD through the first display mode switching circuit 114. The drain electrode (i.e., the third drain electrode) of the second drive transistor DT2 is electrically connected to the anode (i.e., the third end) of the second organic electro-luminescence diode OD2.

When the second organic electro-luminescence device 220 is the bottom-emission organic electro-luminescence device, the second organic electro-luminescence diode OD2 is correspondingly a bottom-emissive organic electro-luminescence diode. When the second organic electro-luminescence device 220 is the top-emission organic electro-luminescence device, the second organic electro-luminescence diode OD2 is correspondingly a top-emissive organic electro-luminescence diode. When the second organic electro-luminescence device 220 is the dual-emission organic electro-luminescence device, the second organic electro-luminescence diode OD2 is correspondingly a dual-emissive organic electro-luminescence diode.

Based on the above, when the first switching transistor ST1 is controlled by the scan signal SCN and thus switched on, the data signal Vdata is transmitted to the gate electrode of the first drive transistor DT1 and the gate electrode of the second drive transistor DT2. Namely, the first organic electro-luminescence device 210 and the second organic electro-luminescence device 220 are deemed to be electrically connected to the same data line 110 and receive the same data signal Vdata. Here, luminance of the first organic electro-luminescence diode OD1 corresponds to the voltage level of the data signal Vdata.

When the first display mode switching transistor ST1 is controlled by the mode switching signal SW1 and is thus not switched on, the second organic electro-luminescence diode OD2 does not emit light because no electric current passes through the second organic electro-luminescence diode OD2. When the first display mode switching transistor MST1 is controlled by the mode switching signal SW1 and is then switched on, the second organic electro-luminescence diode OD2 emits light because the electric current passes through the second organic electro-luminescence diode OD2. Besides, the luminance of the second organic electro-luminescence diode OD2 corresponds to the voltage level of the data signal Vdata. When the first switching transistor ST1 is controlled by the scan signal SCN and is thus not switched on, the first capacitor C1 can maintain the voltage level of the gate electrode of the first drive transistor DT1 and the voltage level of the gate electrode of the second drive transistor DT2.

Based on the above, whether the second organic electro-luminescence device 220 emits light or not is determined by switching on or switching off the first display mode switching transistor MST1. Additionally, when the first organic electro-luminescence device 210 is the dual-emission organic electro-luminescence device, the second organic electro-luminescence device 220 can be used to enhance image brightness in a certain direction (e.g., the front side or the back side). When the first organic electro-luminescence device 210 is the single-emissive device (e.g., the top-emission organic electro-luminescence device or the bottom emissive device), the second organic electro-luminescence device 220 can be used to switch the organic electro-luminescence display panel 100 to be a single-emissive display panel or a dual-emissive display panel. Since the first display mode switching transistor MST1 is electrically connected to all of the second organic electro-luminescence devices 220 directly, the display mode can be switched in a rapid and direct mode without being controlled by external integrated circuits (IC). As such, undesired delay in frame displaying does not occur, and power consumption can be lowered down.

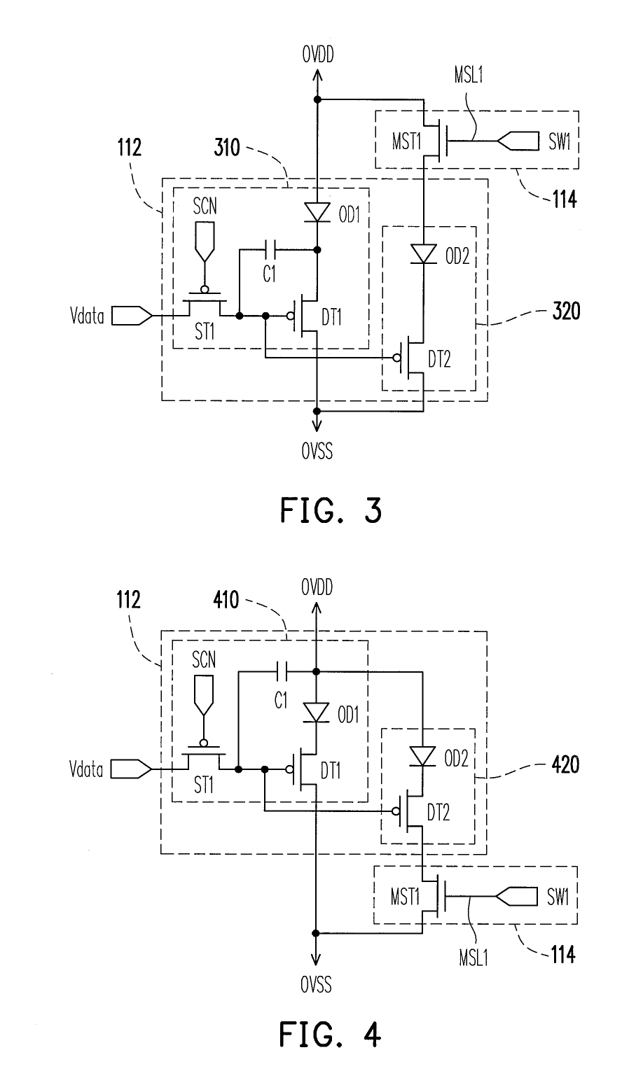

FIG. 3 is a schematic circuit diagram illustrating a portion of the first display mode switching circuit 114 and the organic electro-luminescence display pixel 112 according to a second embodiment of the invention. With reference to FIG. 2 and FIG. 3, the structure and the circuit operation of this embodiment are similar to those described in the embodiment depicted in FIG. 2. The difference therebetween lies in that the first switching transistor ST1, the first drive transistor DT1, and the second drive transistor DT2 in the embodiment depicted in FIG. 2 are NMOS transistors, for instance, while the first switching transistor ST1, the first drive transistor DT1, and the second drive transistor DT2 in this embodiment are PMOS transistors, for instance.

As comparatively shown in FIG. 2 and FIG. 3, in the first organic electro-luminescence device 310 of this embodiment, the anode of the first organic electro-luminescence diode OD1 is electrically connected to the first voltage source OVDD, the cathode of the first organic electro-luminescence diode OD1 is electrically connected to the source electrode of the first drive transistor DT1, and the drain electrode of the first drive transistor DT1 is electrically connected to the second voltage source OVSS. In the second organic electro-luminescence device 320 of this embodiment, the anode of the second organic electro-luminescence diode OD2 is electrically connected to the drain electrode of the first display mode switching transistor MST1, so as to electrically connect the first voltage source OVDD through the first display mode switching circuit 114. The cathode of the second organic electro-luminescence diode OD2 is electrically connected to the source electrode of the second drive transistor DT2, and the drain electrode of the second drive transistor DT2 is electrically connected to the second voltage source OVSS.

FIG. 4 is a schematic circuit diagram illustrating a portion of the first display mode switching circuit 114 and the organic electro-luminescence display pixel 112 according to a third embodiment of the invention. With reference to FIG. 3 and FIG. 4, the circuit operation of this embodiment is similar to that described in the embodiment depicted in FIG. 3. Besides, the first organic electro-luminescence device 410 and the first organic electro-luminescence device 310 are structurally similar, and the second organic electro-luminescence device 420 and the second organic electro-luminescence device 320 are structurally similar. The difference therebetween lies in that the first capacitor C1 of this embodiment is coupled between the drain electrode of the first switching transistor ST1 and the first voltage source OVDD, and the first display mode switching circuit 114 is coupled between the second organic electro-luminescence device 420 and the second voltage source OVSS. The second organic electro-luminescence device 420 is electrically connected to the second voltage source OVSS through the first display mode switching circuit 114.

To be more specific, in the second organic electro-luminescence device 420, the anode of the second organic electro-luminescence diode OD2 is electrically connected to the first voltage source OVDD. The drain electrode of the second drive transistor DT2 is electrically connected to the source electrode of the first display mode switching transistor MST1, so as to electrically connect the second voltage source OVSS through the first display mode switching circuit 114.

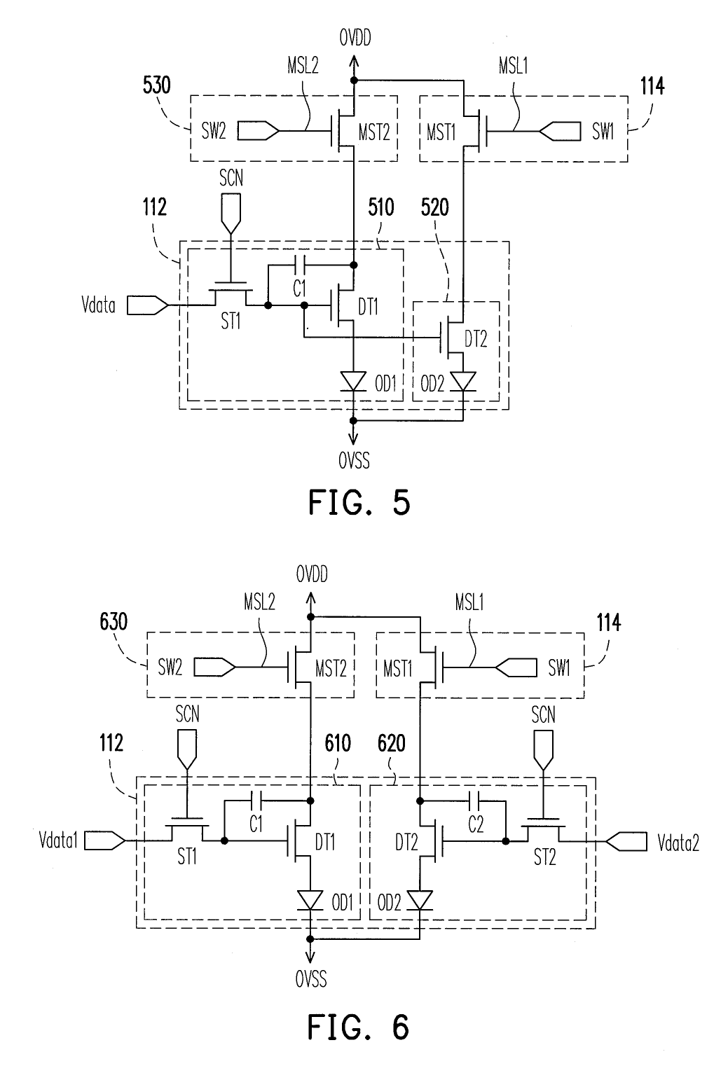

FIG. 5 is a schematic circuit diagram illustrating a portion of the first display mode switching circuit 114, the organic electro-luminescence display pixel 112, and a portion of the second display mode switching circuit 530 according to a fourth embodiment of the invention. With reference to FIG. 1, FIG. 2 and FIG. 5, the circuit operation of this embodiment is similar to that described in the embodiment depicted in FIG. 2. Besides, the first organic electro-luminescence device 510 and the first organic electro-luminescence device 210 are structurally similar, and the second organic electro-luminescence device 520 and the second organic electro-luminescence device 220 are structurally similar. The difference therebetween lies in that the organic electro-luminescence display panel of this embodiment further includes a second display mode switching circuit 530 coupled between the first organic electro-luminescence device 510 and the first voltage source OVDD.

The second display mode switching circuit 530 is structurally similar to the first display mode switching circuit 114 and is also configured in the peripheral region 106 of the substrate 102. People having ordinary skill in the art should be aware of the configuration of the second display mode switching circuit 530 by referring to the descriptions of the first display mode switching circuit 114, and therefore no further descriptions are provided herein. The second display mode switching circuit 530 includes a second display mode switching transistor MST2 and a second display mode switching line MSL2. The gate electrode of the second display mode switching transistor MST2 is electrically connected to the second display mode switching line MSL2 to receive a mode switching signal SW2. The source electrode of the second display mode switching transistor MST2 is electrically connected to the first voltage source OVDD. The drain electrode of the second display mode switching transistor MST2 is electrically connected to the source electrode of the first drive transistor DT1 of the first organic electro-luminescence device 510.

Here, the mode switching signals SW1 and SW2 respectively determine whether the first display mode switching transistor MST1 and the second display mode switching transistor MST2 are switched on or not. If both the first display mode switching transistor MST1 and the second display mode switching transistor MST2 are not switched on, images cannot be displayed. Hence, at least one of the first display mode switching transistor MST1 and the second display mode switching transistor MST2 is in an on state.

FIG. 6 is a schematic circuit diagram illustrating a portion of the first display mode switching circuit 114, the organic electro-luminescence display pixel 112, and a portion of the second display mode switching circuit 630 according to a fifth embodiment of the invention. With reference to FIG. 5 and FIG. 6, the circuit operation of this embodiment is similar to that described in the embodiment depicted in FIG. 5. Besides, the first organic electro-luminescence device 610 and the first organic electro-luminescence device 510 are structurally similar, and the second display mode switching circuit 630 and the second display mode switching circuit 530 are structurally similar. The difference therebetween lies in that the second organic electro-luminescence device 620 of this embodiment further includes the second switching transistor ST2 and the second capacitor C2.

In the second organic electro-luminescence device 620, the gate electrode of the second switching transistor ST2 is electrically connected to the corresponding scan line 108 to receive the corresponding scan signal SCN, and the source electrode of the second switching transistor ST2 receives the corresponding data signal Vdata2. The second capacitor C2 is coupled between the drain electrode of the second switching transistor ST2 and the source electrode of the second drive transistor DT2. Here, it is presumed that the gate electrode of the first switching transistor ST1 and the gate electrode of the second switching transistor ST2 are electrically connected to the same scan line 108 to receive the same scan signal SCN, and that the source electrode of the first switching transistor ST1 and the source electrode of the second switching transistor ST2 respectively receive the data signals Vdata1 and Vdata2. Here, the data signals Vdata1 and Vdata2 are different and can be transmitted through different data lines 110.

Thereby, if the first organic electro-luminescence device 610 and the second organic electro-luminescence device 620 are respectively the bottom-emission organic electro-luminescence device and the top-emission organic electro-luminescence device, different images can be displayed on the front side and the back side of the organic electro-luminescence display panel 100. Moreover, whether the images are displayed or not is determined by the first display mode switching circuit 114 and the second display mode switching circuit 630. In other embodiments of the invention, one of the first display mode switching circuit 114 and the second display mode switching circuit 630 can be omitted.

Additionally, in the previous embodiments, the scan lines, the data lines, the first and second organic electro-luminescence devices, and the first display mode switching circuit and/or the second display mode switching circuit can be together considered as a switchable organic electro-luminescence display circuit. Electrical connecting correlations (or the coupling correlations) between the source electrodes and the drain electrodes of the transistors are exchangeable without interfering with the aforesaid embodiments. Moreover, the previous embodiments are merely exemplary, and circuit structures derived from descriptions of the previous embodiments can also be considered as the embodiments of the invention, which should not be construed as limitations to this invention.

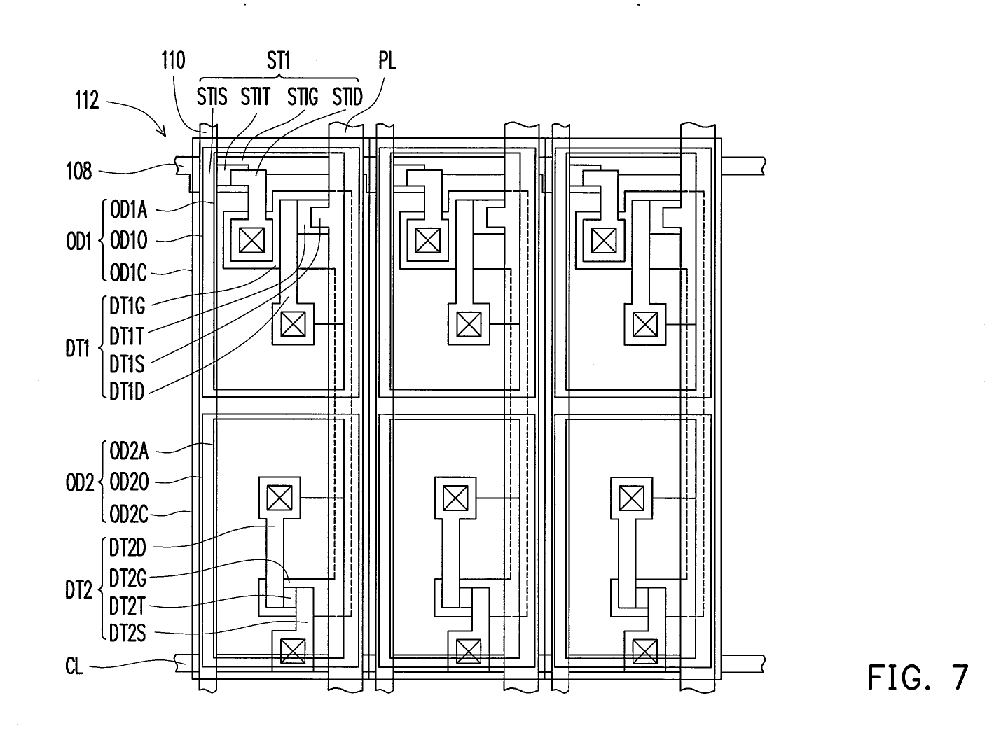

FIG. 7 is a top view illustrating the organic electro-luminescence display pixel 112 according to an embodiment of the invention. With reference to FIG. 7, in the organic electro-luminescence display pixel 112 of this embodiment, the gate electrodes ST1G of the first switching transistors ST1 are coupled to the scan lines 108, and the source electrodes ST1S of the first switching transistors ST1 are coupled to the data lines 110. Channel layers ST1T are configured on the gate electrodes ST1G of the first switching transistors ST1 and electrically connected to the source electrodes ST1S and the drain electrodes ST1D of the first switching transistors ST1. The drain electrodes ST1D of the first switching transistors ST1 are coupled to the gate electrodes DT1G of the first drive transistors DT1 and the gate electrodes DT2G of the second drive transistors DT2. Here, the gate electrodes DT1G of the first drive transistors DT1 are electrically connected to the gate electrodes DT2G of the second drive transistors DT2.

The channel layers DT1T are configured on the gate electrodes DT1G of the first drive transistors DT1 and electrically connected to the source electrodes DT1S and the drain electrodes DT1D of the first drive transistors DT1. The source electrodes DT1S of the first drive transistors DT1 are electrically connected to the power lines PL, so as to receive the first voltage source OVDD. The drain electrodes DT1D of the first drive transistors DT1 are electrically connected to the anodes OD1A of the first organic electro-luminescence diodes OD1, and organic functional layers OD1O and the cathodes OD1C of the first organic electro-luminescence diodes OD1 are sequentially configured on the anodes OD1A of the first organic electro-luminescence diodes OD1. Here, the organic functional layers OD1O at least include organic light emitting layers. Alternatively, the organic functional layers OD1O can include electron transporting layers, hole transporting layers, and so on. Since this is well known to people having ordinary skill in the art, no further descriptions in this regard will be provided hereinafter.

On the other hand, the channel layers DT2T are configured on the gate electrodes DT2G of the second drive transistors DT2 and electrically connected to the source electrodes DT2S and the drain electrodes DT2D of the second drive transistors DT2. The source electrodes DT2S of the second drive transistors DT2 are electrically connected to the connection lines CL, so as to electrically connect the source electrodes or the drain electrodes of the first display mode switching transistors MST1. The drain electrodes DT2D of the second drive transistors DT2 are electrically connected to the anodes OD2A of the second organic electro-luminescence diodes OD2, and organic functional layers OD2O and the cathodes OD2C of the second organic electro-luminescence diodes OD2 are sequentially configured on the anodes OD2A of the second organic electro-luminescence diodes OD2. Here, the organic functional layers OD2O are similar to the organic functional layers OD1O, and therefore no further descriptions are provided hereinafter.

Besides, when the first organic electro-luminescence diodes OD1 and the second organic electro-luminescence diodes OD2 emit red light, the organic electro-luminescence display pixels 112 are red pixels; when the first organic electro-luminescence diodes OD1 and the second organic electro-luminescence diodes OD2 emit green light, the organic electro-luminescence display pixels 112 are green pixels; when the first organic electro-luminescence diodes OD1 and the second organic electro-luminescence diodes OD2 emit blue light, the organic electro-luminescence display pixels 112 are blue pixels. Note that the above descriptions are exemplary and are not intended to limit the invention.

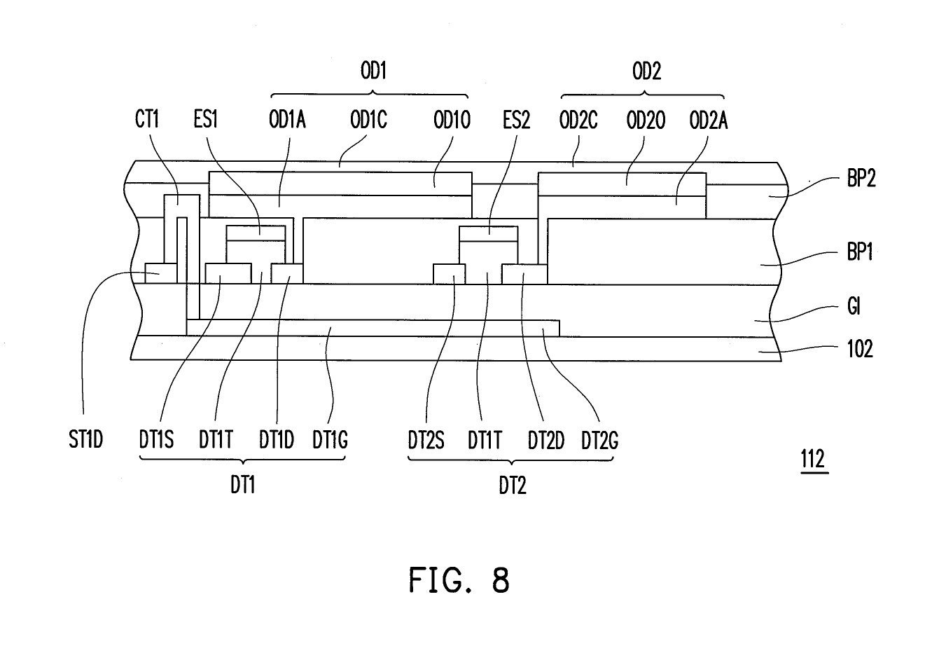

FIG. 8 is a cross-sectional view illustrating a portion of the organic electro-luminescence display pixel 112 according to an embodiment of the invention. With reference to FIG. 8, in this embodiment, the gate electrode DT1G of the first drive transistor DT1 and the gate electrode DT2G of the second drive transistor DT2 are electrically connected and configured on the substrate 102. A gate insulating layer GI is configured on the gate electrode DT1G of the first drive transistor DT1, the gate electrode DT2G of the second drive transistor DT2, and the substrate 102. The channel layers DT1T and DT2T, the source electrode DT1S and the drain electrode DT1D of the first drive transistor DT1, the source electrode DT2S and the drain electrode DT2D of the second drive transistor DT2, and the drain electrode ST1D of the first switching transistor ST1 are configured on the gate insulating layer GI.

The channel layer DT respectively covers the source electrode DT and the drain electrode DT1D of the first drive transistor DT1, and the channel layer DT2T respectively covers the source electrode DT2S and the drain electrode DT2D of the first drive transistor DT2. In addition, etch stop layers ES1 and ES2 are respectively configured on the channel layers DT1T and DT2T. Protection layers BP1 and BP2 are sequentially configured on the etch stop layers ES1 and ES2, the source electrode DT and the drain electrode DT1D of the first drive transistor DT1, the source electrode DT2S and the drain electrode DT2D of the second drive transistor DT2, and the drain electrode ST1D of the first switching transistor ST1. The protection layer BP2 is etched to form holes in the first organic electro-luminescence diode OD1 and the second organic electro-luminescence diode OD2.

A connection line CT1 is configured between the protection layers BP1 and BP2 to connect the gate electrode DT1G of the first drive transistor DT1, the gate electrode DT2G of the second drive transistor DT2, and the drain electrode ST1D of the first switching transistor ST1. Here, the connection line CT1 passes through the protection layer BP1 and the gate insulating layer GI to electrically connect the gate electrode DT1G of the first drive transistor DT1 and the gate electrode DT2G of the second drive transistor DT2. The connection line CT1 further passes through the protection layer BP1 to electrically connect the drain electrode ST1D of the first switching transistor ST1.

The anode OD1A of the first organic electro-luminescence diode OD1 and the organic functional layer OD1O as well as the anode OD2A of the second organic electro-luminescence diode OD2 and the organic functional layer OD2O are sequentially configured in the two holes of the protection layer BP2, respectively. The cathode OD1C of the first organic electro-luminescence diode OD1 and the cathode OD2C of the second organic electro-luminescence diode OD2 are then configured on the protection layer BP2 and the organic functional layers OD1O and OD2O. Here, the cathode OD1C is electrically connected to the cathode OD2C.

The first and second organic electro-luminescence diodes OD1 and OD2 can be controlled to emit light in an upward mode, in a downward mode, or in a double-sided mode according to the material of electrodes. For instance, when the first organic electro-luminescence diode OD1 emits light in an upward mode, and the second organic electro-luminescence diode OD2 emits light in a double-sided mode, the anode OD1A of the first organic electro-luminescence diode OD1 can be made of a single-layered non-transparent conductive layer or a layer in which a non-transparent conductive layer and a transparent conductive layer are stacked together. The material of the non-transparent conductive layer is metal, and the material of the transparent conductive layer is indium tin oxide (ITO), for instance. The cathode OD1C of the first organic electro-luminescence diode OD1 can be made of a transparent conductive layer, e.g., an ITO layer, so as to emit light in an upward mode. Besides, the anode OD2A and the cathode OD2C of the second organic electro-luminescence diode OD2 can both be made of a transparent conductive layer, e.g., an ITO layer, so as to emit light in a double-sided mode. In addition to the above, people having ordinary skill in the art can also properly adjust positions where the non-light-transmissive conductive layers are formed, so as to control the light emitting directions.

In light of the foregoing, in the organic electro-luminescence display panel and the switchable organic electro-luminescence display circuit of the invention, each of the organic electro-luminescence display pixels has the first and second organic electro-luminescence devices. A display mode switching circuit is used to control the first organic electro-luminescence device or the second organic electro-luminescence device.

The first organic electro-luminescence device and the second organic electro-luminescence device emit light in different mode. Thereby, the organic electro-luminescence display panel can be switched to have different display effects. Since the first display mode switching transistor is electrically connected to all of the second organic electro-luminescence devices directly, the display mode can be switched in a rapid and direct manner. As such, undesired delay in frame displaying does not occur, and power consumption can be lowered down.

It will be apparent to those skilled in the art that various modifications and variations can be made to the invention without departing from the scope or spirit of the invention. In view of the foregoing, it is intended that the invention cover modifications and variations of this invention provided they fall within the scope of the following claims and their equivalents.

What is claimed is:

1. A switchable organic electro-luminescence display panel comprising:
a substrate having a display region and a peripheral region;
a plurality of scan lines configured on the substrate;
a plurality of data lines configured on the substrate and intersected with the scan lines;
a plurality of organic electro-luminescence display pixels configured in the display region, each of the organic electro-luminescence display pixels being electrically connected to one of the scan lines and one of the data lines correspondingly and each of the organic electro-luminescence display pixels comprising:
a first organic electro-luminescence device coupled between a first voltage source and a second voltage source;
a second organic electro-luminescence device coupled between the first voltage source and the second voltage source, the first organic electro-luminescence device and the second organic electro-luminescence device being electrically connected to one of the scan lines and emitting light in different mode; and
a first display mode switching circuit configured in the peripheral region and comprising:
a first display mode switching line; and
at least one first display mode switching transistor comprising a first display switching gate electrode, a first display switching source/drain electrode, and a second display switching source/drain electrode, the first display switching gate electrode being electrically connected to the first display mode switching line, the first display switching source/drain electrode being electrically connected to the first voltage source, the second display switching source/drain electrode being electrically connected to all of the second organic electro-luminescence devices.

2. The switchable organic electro-luminescence display panel as claimed in claim 1, wherein the first organic electro-luminescence device is a bottom-emission organic electro-luminescence device, a top-emission organic electro-luminescence device, or a dual-emission organic electro-luminescence device, and the second organic electro-luminescence device is a bottom-emission organic electro-luminescence device, a top-emission organic electro-luminescence device, or a dual-emission organic electro-luminescence device.

3. The switchable organic electro-luminescence display panel as claimed in claim 1, wherein the first organic electro-luminescence device and the second organic electro-luminescence device in each of the organic electro-luminescence display pixels are electrically connected to one of the data lines.

4. The switchable organic electro-luminescence display panel as claimed in claim 1, further comprising a second display mode switching circuit, wherein each of the first organic electro-luminescence devices is electrically connected to the first voltage source through the second display mode switching circuit.

5. The switchable organic electro-luminescence display panel as claimed in claim 1, wherein the first organic electro-luminescence device in each of the organic electro-luminescence display pixels comprises:
a first organic electro-luminescence diode having a first end and a second end, the second end being electrically connected to the second voltage source;
a switching transistor having a first gate electrode, a first source electrode, and a first drain electrode, the first gate electrode being electrically connected to one of the scan lines, the first source electrode being electrically connected to one of the data lines correspondingly;
a first drive transistor having a second gate electrode, a second source electrode, and a second drain electrode, the second gate electrode being electrically connected to the first drain electrode, the second source electrode being electrically connected to the first voltage source, the second drain electrode being electrically connected to the first end; and
a capacitor coupled between the first drain electrode and the second source electrode.

6. The switchable organic electro-luminescence display panel as claimed in claim 5, wherein the second organic electro-luminescence device in each of the organic electro-luminescence display pixels comprises:
a second organic electro-luminescence diode having a third end and a fourth end, the fourth end being electrically connected to the second voltage source; and
a second drive transistor having a third gate electrode, a third source electrode, and a third drain electrode, the third gate electrode being electrically connected to the first drain electrode, the third source electrode being electrically connected to the first voltage source through the first display mode switching circuit, the third drain electrode being electrically connected to the third end.

7. The switchable organic electro-luminescence display panel as claimed in claim 1, wherein the first organic electro-luminescence device in each of the organic electro-luminescence display pixels comprises:
a first organic electro-luminescence diode having a first end and a second end, the first end being electrically connected to the first voltage source;
a switching transistor having a first gate electrode, a first source electrode, and a first drain electrode, the first gate electrode being electrically connected to one of the scan lines, the first source electrode being electrically connected to one of the data lines correspondingly;
a first drive transistor having a second gate electrode, a second source electrode, and a second drain electrode, the second gate electrode being electrically connected to the first drain electrode, the second source electrode being electrically connected to the second end, the second drain electrode being electrically connected to the second voltage source; and
a capacitor coupled between the first drain electrode and the second source electrode or between the first drain electrode and the first voltage source.

8. The switchable organic electro-luminescence display panel as claimed in claim 7, wherein the second organic electro-luminescence device in each of the organic electro-luminescence display pixels comprises:
a second organic electro-luminescence diode having a third end and a fourth end, the third end being electrically connected to the first voltage source through the first display mode switching circuit; and
a second drive transistor having a third gate electrode, a third source electrode, and a third drain electrode, the third gate electrode being electrically connected to the first drain electrode, the third source electrode being electrically connected to the fourth end, the third drain electrode being electrically connected to the second voltage source.

9. The switchable organic electro-luminescence display panel as claimed in claim 7, wherein the second organic electro-luminescence device in each of the organic electro-luminescence display pixels comprises:
a second organic electro-luminescence diode having a third end and a fourth end, the third end being electrically connected to the first voltage source; and
a second drive transistor having a third gate electrode, a third source electrode, and a third drain electrode, the third gate electrode being electrically connected to the first drain electrode, the third source electrode being electrically connected to the fourth end, the third drain electrode being electrically connected to the second voltage source through the first display mode switching circuit.

10. The switchable organic electro-luminescence display panel as claimed in claim 1, wherein the first organic electro-luminescence device and the second organic electro-luminescence device in each of the organic electro-luminescence display pixels are electrically connected to different data lines of the data lines.

11. The switchable organic electro-luminescence display panel as claimed in claim 10, wherein the first organic electro-luminescence device in each of the organic electro-luminescence display pixels comprises:
a first organic electro-luminescence diode having a first end and a second end, the second end being electrically connected to the second voltage source;
a first switching transistor having a first gate electrode, a first source electrode, and a first drain electrode, the first gate electrode being electrically connected to one of the scan lines, the first source electrode being electrically connected to one of the data lines correspondingly;
a first drive transistor having a second gate electrode, a second source electrode, and a second drain electrode, the second gate electrode being electrically connected to the first drain electrode, the second source electrode being electrically connected to the first voltage source, the second drain electrode being electrically connected to the first end; and
a first capacitor coupled between the first drain electrode and the second source electrode.

12. The switchable organic electro-luminescence display panel as claimed in claim 11, wherein the second organic electro-luminescence device in each of the organic electro-luminescence display pixels comprises:
a second organic electro-luminescence diode having a third end and a fourth end, the third end being electrically connected to the second voltage source;
a second switching transistor having a third gate electrode, a third source electrode, and a third drain electrode, the third gate electrode being electrically connected to one of the scan lines, the third source electrode being electrically connected to one of the data lines correspondingly;
a second drive transistor having a fourth gate electrode, a fourth source electrode, and a fourth drain electrode, the fourth gate electrode being electrically connected to the third drain electrode, the fourth source electrode being electrically connected to the first voltage source, the fourth drain electrode being electrically connected to the third end; and
a second capacitor coupled between the third drain electrode and the fourth source electrode.

13. A switchable organic electro-luminescence display panel comprising:
a substrate having a display region and a peripheral region;
a plurality of scan lines configured on the substrate;
a plurality of data lines configured on the substrate and intersected with the scan lines;
a plurality of organic electro-luminescence display pixels configured in the display region, each of the organic electro-luminescence display pixels being electrically connected to one of the scan lines and one of the data lines correspondingly and each of the organic electro-luminescence display pixels comprising:
a first organic electro-luminescence device;
a second organic electro-luminescence device, the first organic electro-luminescence device and the second organic electro-luminescence device being electrically connected to one of the scan lines and emitting light in different mode; and
a first display mode switching circuit configured in the peripheral region, wherein each of the first organic electro-luminescence devices is forward-coupled between a first voltage source and a second voltage source, and each of the second organic electro-luminescence devices is electrically connected to the first voltage source or the second voltage source through the first display mode switching circuit.

14. A switchable organic electro-luminescence display circuit comprising:
a plurality of scan lines;
a plurality of data lines intersected with the scan lines;
a plurality of first organic electro-luminescence devices, each of the first organic electro-luminescence devices being electrically connected to one of the scan lines and one of the data lines correspondingly and coupled between a first voltage source and a second voltage source;
a plurality of second organic electro-luminescence devices, each of the second organic electro-luminescence devices being electrically connected to one of the scan lines and one of the data lines correspondingly and coupled to the first voltage source;
a first display mode switching line; and
at least one first display mode switching transistor comprising a first display switching gate electrode, a first display switching source/drain electrode, and a second display switching source/drain electrode, the first display switching gate electrode being electrically connected to the first display mode switching line, the first display switching source/drain electrode being electrically connected to the second voltage source, the second display switching source/drain electrode being electrically connected to all of the second organic electro-luminescence devices.
